(19) United States
(12) Patent Application Publication
(10) Pub. No.: US 2002/0184362 A1
(43) Pub. Date: Dec. 5, 2002

(54) System and method for extending server security through monitored load management

(75) Inventors: Dwip N. Banerjee, Austin, TX (US); Vinit Jain, Austin, TX (US); Vasu Vallabhaneni, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 09/870,610

(22) Filed: May 31, 2001

(51) Int. Cl. G06F 15/173; G06F 15/16

(52) U.S. Cl. 709/224; 709/229

(57) ABSTRACT

A system and method for extending server security based on source IP addresses is provided. When the server receives a packet request, it determines if the request is legitimate or a malicious attempt to cause denial of service. The determination is made by a server background IP packet monitor that looks up the amount of packets previously requested by the same source IP address in a given time interval. If the packet request is legitimate, the server processes the request and sends a response to the client. If the server background IP packet monitor determines that the packet request was from a malicious client, an predetermined action is taken. The action can be notifying the system administrator or denying the packet request and not sending a response.

### BACKGROUND OF THE INVENTION

1. Technical Field

The present invention relates in general to a method and system for extending server security through monitored load management. Still more particularly, the present invention relates to a method and system for monitoring client's usage on servers based on source IP addresses.

2. Description of the Related Art

The Internet has changed the way people do business. Someone can now access a vast array of information from around the world in less than a second. Businesses need to be connected to the Internet, and have fast servers with a proper network infrastructure in place. Without this infrastructure, customers simply will not be tolerant of slow responses when requesting information.

While business servers need to have quick response time to customers, they also need to watch for malicious clients. Malicious clients are users that attempt to bring a server down in a variety of ways and cause a denial of service to other valid customers.

Brute-force denial of service attacks have a long history in the computer underground, largely because they are a relatively easy way to wreak havoc with outside computers or Web sites. One way a denial of service outage occurs is when attackers bombard a Web site's servers with fake packets of information requests. When the targeted server responds, the attackers' system steps up the barrage by sending more requests. The affected Web site struggles to keep up with the mounting number of requests, slowing performance for users or ultimately causing the server to fail.

In one of the most common forms, an attacker takes over another machine, or a group of machines connected to the Internet, and then programs these “slave” machines to send streams of information at the target site. Commonly, these streams will take the form of a “ping” command—a basic, low-bandwidth way for one machine to query whether another machine on the network exists.

One ping at a time is almost indistinguishable from the flow of traffic around it. However, when many pings are sent within a small timeframe, the resulting traffic can clog networks or cause servers and router systems to become overloaded and fail.

Another way to cause a denial of service is to infect a large number of computers with a program that sends out malformed Internet Control Message Protocol (ICMP) requests. Acting in unison, the infected computers launch massive data requests at a targeted Web site, overwhelming the routers that ship requests for pages and data to the many site servers that then answer Web audiences' requests.

When a server receives the malformed information “packets,” a targeted router computer is stalled while it tries to determine how to handle the strange, unrecognizable data. Meanwhile, more malformed packets arrive at the router. Very soon the system is overwhelmed by the bad data and performance deteriorates considerably.

Still one other way to cause a denial of service involves brute force software which connects to a password protected members area of a Web site and automatically sends thousands of requests to the server attempting to guess a correct username and password for the system. The malicious software uses a very large list of words (like a dictionary) that are likely username and password combinations. This process consumes bandwidth and system resources. If the attacker is on a high-speed connection, the attack can degrade the Web site's performance and functionality.

If and when the attacker gains access with working codes, he can post the userid and password on any number of password trading Web sites. Many of these Web sites are very popular and may result in many unauthorized individuals gaining access to the protected Web site. If the server running the protected Web site is not set up for the increased traffic, the large volume of requests can overwhelm the server and cause it to be extremely slow or even fail. Some of the more severe cases of members area security breech can cost the site's owner thousands of dollars in bandwidth expenses.

A challenge dealing with malicious clients involves efficiently blocking malicious requests while providing legitimate customers with high-speed server responses. What is needed, therefore, is a way to effectively track usage data for a given client and determine, based on a variety of factors, whether the client is malicious or legitimate based on thresholds that best apply to the given online business.

### SUMMARY

It has been discovered that by tracking incoming packets at the IP layer, client usage statistics can be monitored and action can be taken if a malicious client is suspected. A table is configured that tracks the number of packets received from individual clients within a predetermined time interval. A setup process fine tunes the configured table so that only malicious clients are blocked and legitimate clients' requests are processed. The tuning process may involve a system administrator modifying the configuration values until the system is optimized or may include automated feedback loops that adjust the setup values using test patterns, or scripts, that simulate the behavior of both malicious and legitimate clients.

The configuration file is used during online processing to detect suspected malicious clients. A client's IP address is recorded and a counter is maintained identifying the number of times the client sends requests to the server in a given time interval. If the client surpasses the limit, it is identified as a malicious client and further communications with the client are blocked. In addition, the system may keep track of how many sockets a given client has open to a server. A predetermined limit is used to determine whether the client has opened more sockets than allowed. If the limit is breached, the server does not allow the client to open additional sockets.

Various levels of “maliciousness” may be tracked with differing corresponding actions. A first limit may be established that, when breached, causes a message to be sent to a system administrator notifying the administrator of a potential problem. A second higher limit can also be established that causes communication with the client to be automatically blocked when the second limit is breached.

Collecting data about client usage also allows a Web site to bill customers based on the number of packets requested by a client. In this manner, infrequent use clients may be charged less than more demanding clients. Another way that the collected data can be used is to set customizable service management mechanisms on the server. By recognizing the source IP, the server can customize the data to be transmitted to the client based on past history or user profiles.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a network diagram of a server receiving requests from a legitimate client and a malicious client and providing responses only to the legitimate client;

FIG. 2 is a block diagram of a server background IP packet monitor connected to a network;

FIG. 3 is a flowchart showing a setup process adjusting configuration settings to achieve a desired security level;

FIG. 4 is a flowchart showing a server packet background IP monitor determining whether to respond to a client request based on the client's previous requests and configuration settings;

FIG. 5 is a flowchart showing a server packet background IP monitor determining whether to grant a client's new socket request;

FIG. 6 is a flowchart showing a server packet background IP monitor determining which action to take when the client is over the allowed packet number; and

FIG. 7 is a block diagram of an information handling system capable of performing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

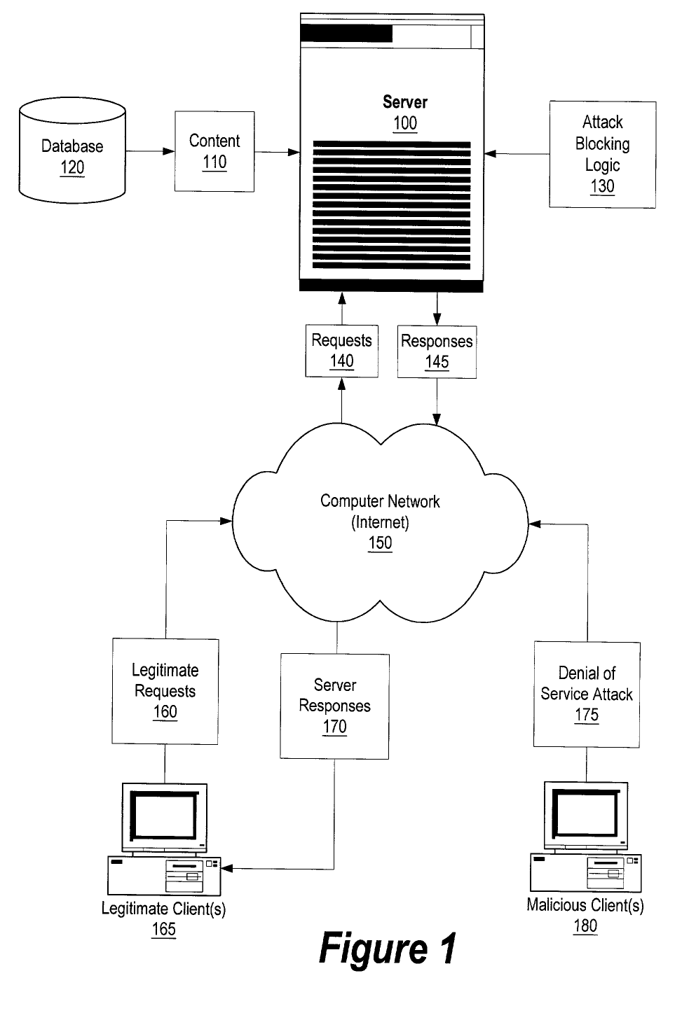

FIG. 1 is a network diagram of server 100 receiving requests 140 from legitimate client 165 and malicious client 175 and providing responses 145 only to the legitimate client. In the diagram shown, Server 100 retrieves content 110 from database 120 when a legitimate request is received. In a large corporation, for example, many servers can be connected to computer network 150 in order to access database 120 and process legitimate client requests. Database 120 is often a separate entity in a large corporation and may employ a database management system (DBMS) for handling requests from the various servers. On the other hand, in a small business, server 100 may be a single computer with database 120 integrated within the computer system and processed by a common processor or processors. Computer network 150 may be a private network accessible by employees of the organization, or may be a public network accessible by anyone. An example of a public computer network is the Internet.

Attack blocking logic 130 monitors packet and socket requests 140 from clients and determines if the requests are legitimate or malicious. Attack blocking logic can be in software, hardware, or a combination of both. If attack blocking logic 130 determines that request 140 is legitimate request 160 from a legitimate client (such as legitimate client 165), attack blocking logic 130 informs server 100 to process the request which often involves retrieving content 110 from database 120 and sending response 145 to the client over computer network 150. Server response 170 includes the packets requested (which may include content 110 retrieved from database 120) and is sent to legitimate client 165. On the other hand, if attack blocking logic 130 determines that request 140 is malicious in nature, such as denial of service attack 175, the attack blocking logic causes server 100 to ignore the malicious request and not send a response.

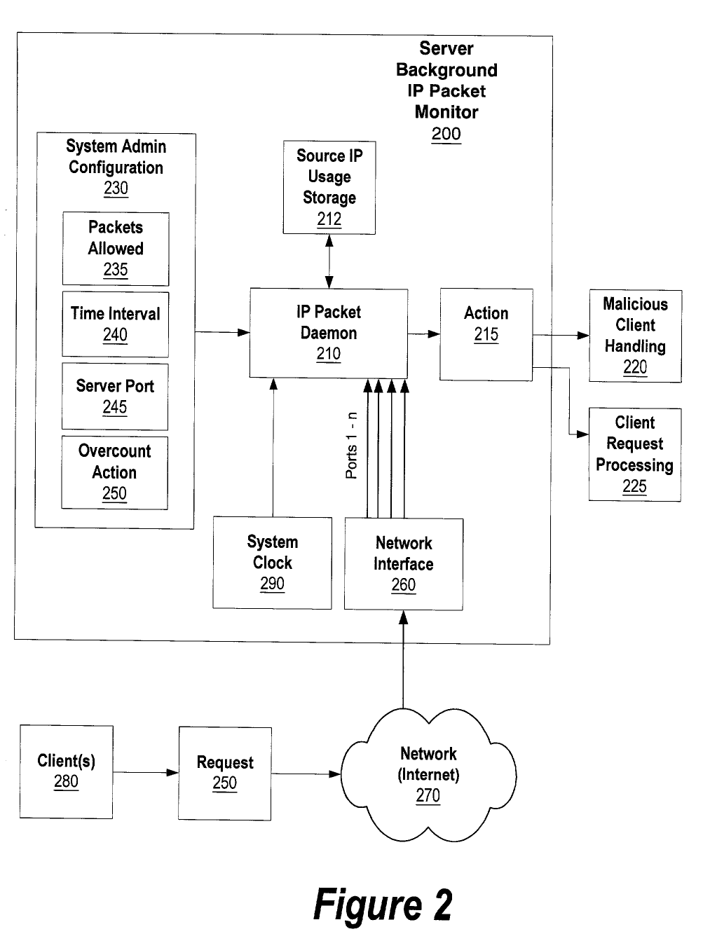

FIG. 2 is a block diagram of server background IP packet monitor 200 connected to computer network 270. Computer network 270 is a network where information is digitally transferred between computers. Computer network 270 may be a private network accessible by employees of the organization (i.e., an intranet), or may be a public network accessible by anyone (i.e., the Internet). Network interface 260 can have several ports connected to computer network 270. For example, a business can have one area for clients to request information (a webpage), but have a plurality of ports available to serve multiple clients requesting information. Network interface 260 may be a modem, a DSL connection, a cable modem, an ISDN connection, a T1 connection, or any number of connection methods known today or developed in the future. Network interface 260 provides client request 250 to IP packet daemon 210 for processing.

If IP packet daemon 210 determines that client 280 is legitimate, client request processing 225 is performed and requested packets are returned to client 280. On the other hand, if IP packet daemon 210 determines that client 280 is malicious, malicious client handling 220 is performed. IP Packet daemon 210 determines as to whether client 280 is legitimate or malicious based on previous requests and system admin configuration 230. System admin configuration 230 includes number packets allowed 235 that informs IP packet daemon how many packets are allowed in specified time interval 240 for client 280. Packets allowed 235 can be different for each client, or can be set to a global limit for many clients.

Time Interval 240 informs IP Packet Daemon 210 of the length of time to monitor the number of packets requested by client 280. The system administrator may adjust the time interval based on the time of day or other factors pertaining to the organization to ensure an accurate security level. For example, a malicious client may be interested in causing a denial of service during daylight hours because a business is experiencing a majority of legitimate requests at that time. A system administrator can increase the security level by lengthening time interval 240 to monitor requests from client 280. The system administrator can also track history usage of a client and adjust security settings appropriately. If a client has a low number of previous requests, and the number of requests drastically increased, the system administrator can be notified sooner. System clock 290 is used by IP packet Daemon 210 for monitoring the time of day and for determining when time interval 240 has elapsed.

System admin configuration 230 also includes server port 245. Server port 245 includes information that informs the IP packet daemon how many allowable sockets each client may have. This is useful in situations where a malicious client is trying to cause a denial of service by capturing multiple sockets.

System admin configuration 230 also includes overcount action 250. Overcount action 250 includes information for IP packet Daemon 210 as to how malicious client handling 220 can be performed. An example of overcount action is to inform the system administrator when the number of packets requested by a client or number of open sockets reaches a first limit. The system administrator can monitor client 280 closely and either increase the security settings for client 280's source IP, or deny request if client 280 is suspected of being malicious. A second overcount action 250 may be to block further requests from a given client when the number of packets requested or the number of open sockets by the client reaches a second limit. The tracking data may further be used to gather evidence that may be useful in prosecuting malicious clients under various laws.

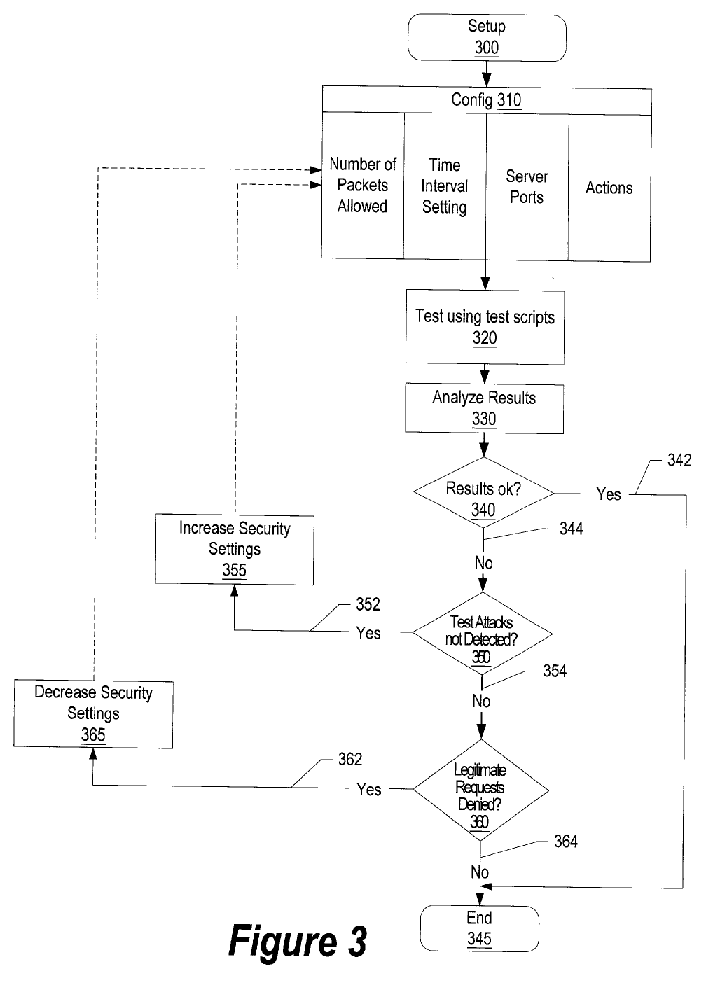

FIG. 3 shows a setup process adjusting the configuration file settings to achieve a desired security level. Setup processing commences at 300 whereupon configuration file 310 is loaded. Once loaded, the system is tested using test scripts (step 320). The results are analyzed (step 330) using either a manual approach wherein a skilled administrator reviews the test results or an automated approach comparing the results to expected values. A determination is made as to whether the configuration file settings are at the proper security level (decision 340). Again, this decision may be a manual decision made by a skilled administrator or by an automated process. If the configuration file is at the right security level, decision 340 branches to “yes” branch 342 whereupon the setup process ends at 345. On the other hand, if the configuration file is not at the right security level, decision 340 branches to “no” branch 344 whereupon a determination is made as to whether the test attacks were detected (decision 350). If test attacks were not detected, decision 350 branches to “yes” branch 352 whereupon the configuration file security settings are increased (step 355) and processing loops back to re-test the test scripts using the revised security settings. On the other hand, if all of the test attacks were detected, decision 350 branches to “no” branch whereupon a determination is made as to whether legitimate client request test were denied (decision 360). If legitimate requests were denied, decision 360 branches to “yes” branch 362 whereupon the configuration file security settings are decreased (step 365). On the other hand, if legitimate requests were not denied, the configuration file is not altered and decision 360 branches to “no” branch 364 whereupon the setup process ends at 345.

A socket is an identifier for a particular service on a particular node on a network. The socket consists of a node address and a port number, which identifies the service. A port number is one of the network input/output channels of a computer running TCP/IP. On the World Wide Web, a port number usually refers to the port number a server is running on. A single computer can have many Web servers running on it, but only one server is running on each port. The default port for Web servers is 80. A message sent over the Internet includes an IP header that identifies the socket, port address, source (i.e., sender) address and destination address. The receiving machine uses the information to put the packet in the appropriate data queue to be processed by the correct packet or process on the receiving machine.

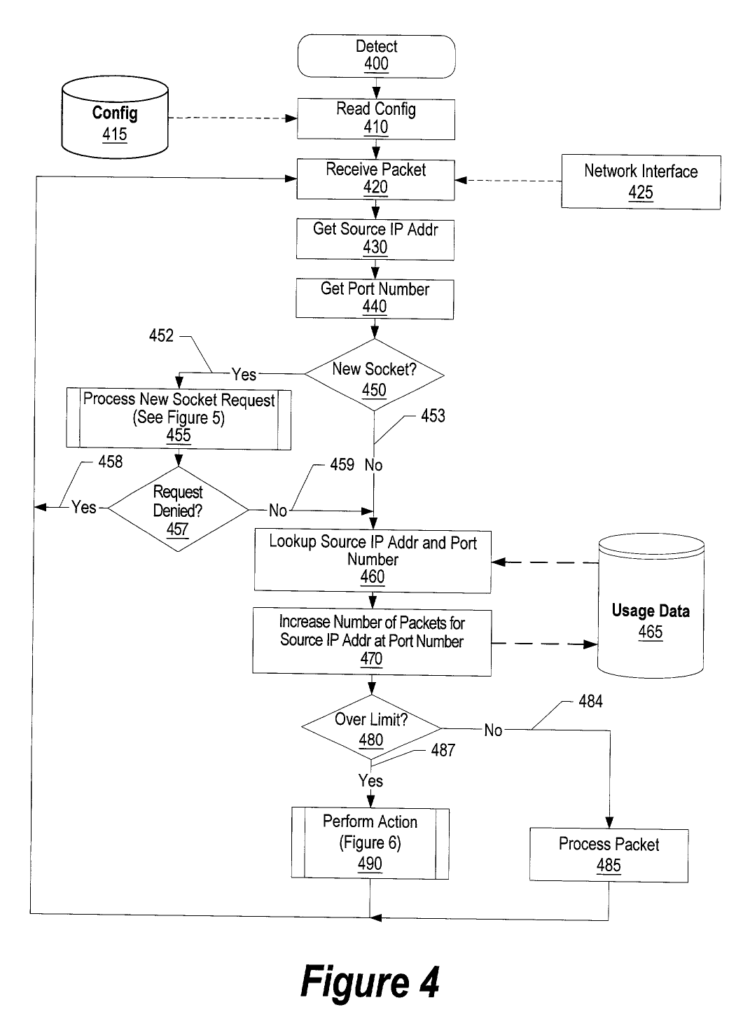

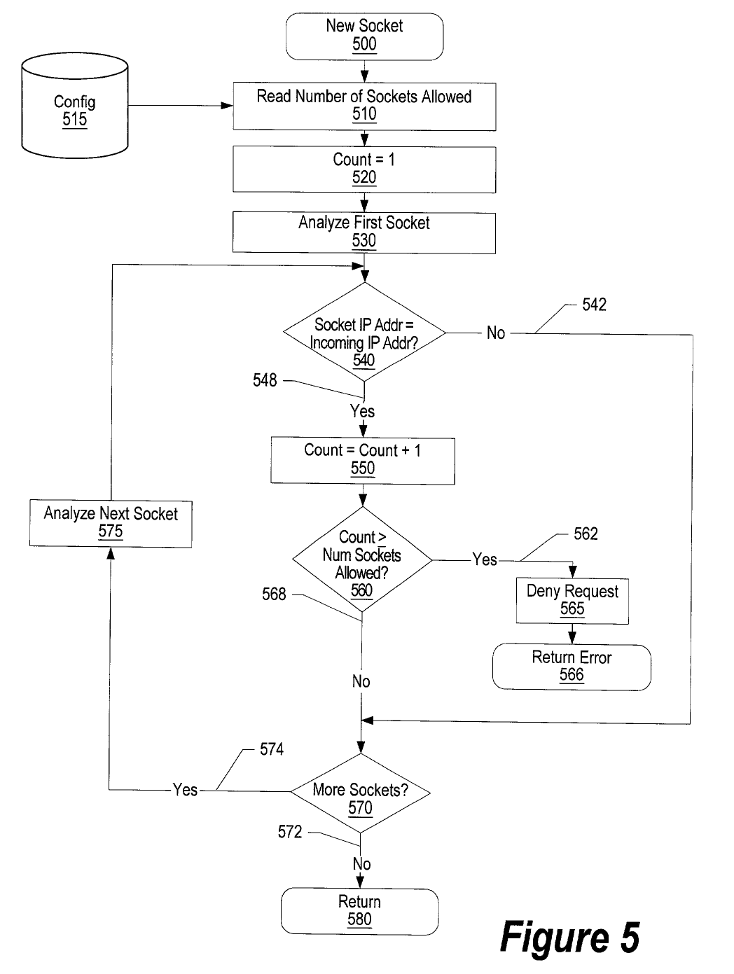

FIG. 4 shows the server packet background IP monitor determining whether to grant a client new packets or new sockets based on the client's previous requests and the server's configuration settings. Processing commences at 400 whereupon security settings stored in configuration file 415 are read (step 410). A packet is received (step 420) from a client computer system through network interface 425 whereupon the source IP address of the client is obtained (step 430) and the client's port number is obtained (step 440). A determination is made as to whether the client is requesting a new socket connection (decision 450). If the client is requesting a new socket connection, decision 450 branches to “yes” branch 452 whereupon the new socket request is processed (pre-defined process 455, see FIG. 5 for further details). A determination is made as to whether the new socket request was denied (decision 457). If the request was denied, decision 457 branches to “yes” branch 458 whereupon processing loops back to handle the next packet from the client. On the other hand, if the socket request was not denied, decision 457 branches to “no” branch 459 whereupon processing of the client's request continues.

If either the client's new socket request was granted (decision 457 branching to “no” branch 459), or the client did not request a new socket (decision 450 branching to “no” branch 453 processing continues to determine whether the client is acting in a malicious manner. The server packet background IP monitor looks up information regarding the source IP address and port number (step 460) from usage data store 465.

The number of packets is incremented for the particular source IP address (step 470). Because the number of packets are tracked for a time interval, at the end of the time interval the number of packets may be reset to zero. Additionally, a rolling time interval may be maintained so that earlier requests that now fall outside the time interval are no longer counted. Resetting to zero allows active clients that may not be malicious to receive further packets when the time interval is over but may also allow malicious clients to consume more server bandwidth. Using a rolling time interval would more effectively block a malicious client as repetitive attacks would cause the client to continually be classified as malicious.

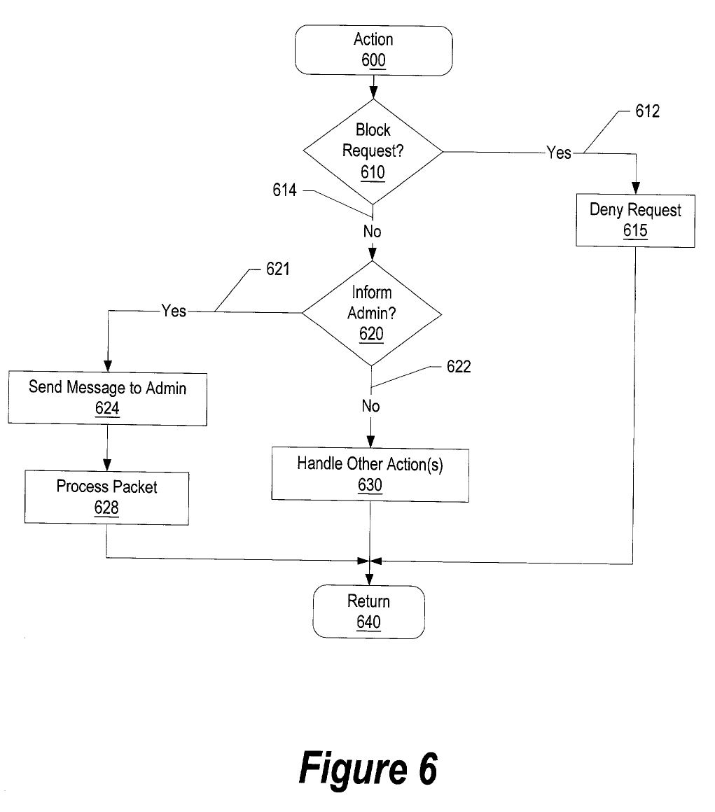

A determination is made as to whether the client is over an allowed limit (decision 480) based on the previously read configuration file security settings (see step 410). If the client is not over the allowed limit, decision 480 branches to “no” branch 484 whereupon the packet is processed (step 485) and the server responds to the client's request. On the other hand, if it was determined that the client is over the allowed limit, decision 480 branches to “yes” branch 487 whereupon an action is performed (pre-defined process 490, see FIG. 6 for further details). Processing then repeatedly loops back to receive and process the next packet from the network interface.

FIG. 5 shows the server packet background IP monitor analyzing a new socket request and making a determination whether to grant the request. Processing commences at 500 whereupon the number of sockets allowed is read (step 510) from configuration data area 515. The socket count is initialized to 1 (step 520) because the client has requested the formation of a new socket. The first socket is analyzed (step 530) to see if it corresponds to the client. If the socket IP address is not the same as the incoming IP address of the client requesting a new socket, decision 540 branches to “no” branch 542 whereupon further sockets are analyzed to determine the number of sockets that correspond to the client. On the other hand, if the incoming IP address of the client is equal to the source IP address, decision 540 branches to “yes” branch 548 whereupon the socket count for the client is incremented by one (step 550). A determination is made as to whether the new socket count is greater than an allowed number of sockets (decision 560) based on the configuration settings for this client. If the new number of sockets is greater than the allowed number, decision 560 branches to “yes” branch 562 whereupon the socket request is denied (step 565) and processing returns an error to the calling routine (return error 566). On the other hand, if the number of sockets is not greater than the number of sockets allowed, decision 560 branches to “no” branch 568 whereupon the server packet background IP monitor checks to see if there are more open sockets to analyze (decision 570). If there are no more sockets to analyze, decision 570 branches to “no” branch 572 whereupon socket processing continues as normal and the routine returns to the calling routine without an error (return 580). On the other hand, there are more sockets to analyze, decision 570 branches to “yes” branch 574 whereupon the next socket is analyzed (step 575) and the processing loops back to process the next socket. This looping continues until all sockets have been processed (return 580) or until the number of sockets opened for the client exceeds the allowed limit (return error 566).

FIG. 6 shows the server packet background IP monitor determining how to handle a request when the client's limit is exceeded. Processing commences at 600 whereupon, based on the security settings read from the configuration file, a determination is made whether to block the packet request (decision 610). If the decision is to block the request, decision 610 branches to “yes” branch 612 whereupon the request is denied (step 615). On the other hand, if the decision was to not block the packet request, decision 610 branches to “no” branch 614 whereupon a determination is made whether to inform the administrator (decision 620). If the configuration settings are such that the administrator wants to be notified when a client goes over a certain limit, decision 620 branches to “yes” branch 621 whereupon a message is sent to the administrator (step 624) and the clients packet is processed (step 628). If decision 620 is not to inform the administrator, then decision 620 branches to “no” branch 622 whereupon other actions are handled (step 630). Other actions may include processing the client's request or denying the client's request based upon the number of client requests. In this manner, the system can provide differing thresholds that still allow a client's request to be handled when the client's usage is not too extreme and then, when the client's usage increases further, deny the client's request altogether. Once the desired action is determined and performed, the server packet background IP monitor stops action processing and returns to the calling routine(return 640).

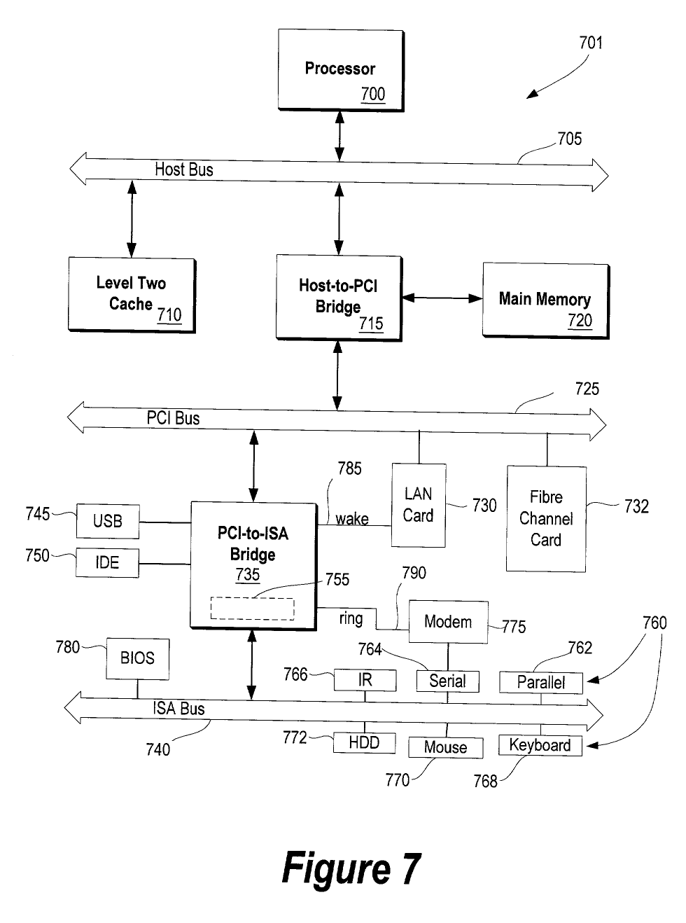

FIG. 7 illustrates information handling system 701 which is a simplified example of a computer system capable of performing the copy processing described herein. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 (e.g., parallel interface 762, serial interface 764, infrared (IR) interface 766, keyboard interface 768, mouse interface 770, and fixed disk (FDD) 772) coupled to ISA bus 740. Alternatively, many I/O devices can be accommodated by a super I/O controller (not shown) attached to ISA bus 740.

BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to attach computer system 701 another computer system to copy files over a network, LAN card 730 is coupled to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the copying processes described herein, this computer system is simply one example of a computer system. Those skilled in the art will appreciate that many other computer system designs are capable of performing the copying process described herein.

One of the preferred implementations of the invention is a client application, namely, a set of instructions (program code) in a code module which may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that is a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for preventing malicious network attacks said method comprising:
receiving a packet from a client computer;
determining a number of packets received during a time interval; and
rejecting the packet in response to the number of packets exceeding a packet limit.

2. The method as described in claim 1 wherein the client computer is identified by a source IP address.

3. The method as described in claim 1 wherein the determining further includes:
identifying a client data area based on a source IP address, the client data area including the number of packets received; and
incrementing the number of packets received.

4. The method described in claim 1 further comprising:
determining an action from a plurality of actions based on the number of packets received; and
executing the action.

5. The method described in claim 1 further comprising:
receiving a socket request from the client computer;
determining a number of sockets opened for the client computer;
comparing the number of sockets opened to a socket limit; and
determining whether to allow a socket request based on the comparison.

6. The method described in claim 1 further comprising:
creating configuration settings, the configuration settings including the packet limit.

7. The method described in claim 6 further comprising:
providing a test script, the test script including one or more attack simulations;
processing the attack simulations included in the test script;
determining whether to change the configuration settings based on the processing; and
changing the configuration settings based on the determination.

8. An information handling system comprising:
one or more processors;
a memory accessible by the processors;
one or more nonvolatile storage devices accessible by the processors;
a network interface for receiving packets from a computer network; and
an packet handling tool to manage packets received from the network interface, the packet handling tool including:
means for receiving a packet from a client computer through the network interface;
means for determining a number of packets received during a time interval; and
means for rejecting the packet in response to the number of packets exceeding a packet limit.

9. The information handling system as described in claim 8 further comprising:
means for identifying the client computer by a source IP address.

10. The information handling system as described in claim 8 wherein the means for determining further includes:
means for identifying a client data area based on a source IP address, the client data area including the number of packets received; and
means for incrementing the number of packets received.

11. The information handling system as described in claim 8 further comprising:
means for receiving a socket request from the client computer;
means for determining a number of sockets opened for the client computer;
means for comparing the number of sockets opened to a socket limit; and
means for determining whether to allow a socket request based on the comparison.

12. The information handling system as described in claim 8 further comprising:
means for creating configuration settings, the configuration settings including the packet limit.

13. The information handling system as described in claim 12 further comprising:
means for providing a test script, the test script including one or more attack simulations;
means for processing the attack simulations included in the test script;
means for determining whether to change the configuration settings based on the processing; and
means for changing the configuration settings based on the determination.

14. A computer program product for preventing malicious network attacks, said computer program product comprising:
means for receiving a packet from a client computer;
means for detecting a number of packets received during a time interval; and
means for rejecting the packet in response to detecting that the number of packets exceeds a packet limit.

15. The computer program product as described in claim 14 wherein the client computer is identified by a source IP address.

16. The computer program product as described in claim 14 wherein the determining further includes:
means for identifying a client data area based on a source IP address, the client data area including the number of packets received; and
means for incrementing the number of packets received.

17. The computer program product described in claim 14 further comprising:
means for determining an action from a plurality of actions based on the number of packets received; and
means for executing the action.

18. The computer program product described in claim 14 further comprising:
means for receiving a socket request from the client computer;
means for determining a number of sockets opened for the client computer;
means for comparing the number of sockets opened to a socket limit; and
means for determining whether to allow a socket request based on the comparison.

19. The computer program product described in claim 14 further comprising:
means for creating configuration settings, the configuration settings including the packet limit.

20. The computer program product described in claim 19 further comprising:
means for providing a test script, the test script including one or more attack simulations;
means for processing the attack simulations included in the test script;
means for determining whether to change the configuration settings based on the processing; and
means for changing the configuration settings based on the determination.
